(19) United States
(12) Patent Application Publication
(10) Pub. No.: US 2007/0240782 A1
(43) Pub. Date: Oct. 18, 2007

(54) SYSTEM AND METHOD FOR PREPARING A FLOWABLE MIXTURE FOR A BATTERY

(76) Inventor: Johan C. Fitter, Johannesburg (ZA)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/279,581

(22) Filed: Apr. 13, 2006

(51) Int. Cl. H01M 4/20

(52) U.S. Cl. 141/1.1; 141/32

(57) ABSTRACT

The invention is a mixing or dosing arrangement (10) for filling a container, conduit or vessel (12), which is used for receiving flowable materials therein from a flowable material combining manifold (58) and to transfer flowable materials therefrom to a suitable battery. The mixing or dosing arrangement (10) has a battery replenishment water source or reservoir (26), a battery condition evaluating composition container (28), and a battery life extending composition container (30) which are all connectable to a flowable material combining manifold (58), with valves used to control the flows for properly dosing the above described fluids as a flowable mixture into the container, vessel or conduit (12), which is used for dosing a battery. The battery condition evaluating composition may be a colorized composition. Colorizing the flowable mixture with a pH sensitive battery evaluating composition makes it possible to use the colorized flowable mixture to identify a battery in a condition that has deteriorated to an extent that a life extending treatment is unlikely to be effective.

### TECHNICAL FIELD

This invention relates to batteries, in particular, lead-acid battery cells that are subject to wear and eventual failure through normal use, and to an electrolyte replenishing system, means and method for evaluating the condition of the battery and whether the battery should either be retired or given a dose of a material for increasing the useful life of the cells, the battery evaluation means based on a colorized indicator composition.

### BACKGROUND

Conventional batteries for use in electric vehicle propulsion, also known as motive power batteries or deep cycling batteries, as well as batteries used in other deep cycling applications, in particular lead-acid batteries, over time are subject to fatigue and deterioration of the integrity of the battery plates. This aspect essentially determines the maximum useful life of these batteries obtainable in normal service.

The useful life of these batteries can be prematurely curtailed due to a variety of factors including, but not limited to, over-discharging, insufficient charging and overheating, which can result in a condition often referred to as “sulfation”.

The addition of a substance to the electrolyte to achieve prolonged battery life is described in U.S. Pat. No. 6,635,387. It has been found, however, that while treatment can serve to prolong the life of batteries that are used generally in accordance with good operating practice, in the case of batteries that have been subject to unsatisfactory operating conditions, including over-discharging, insufficient charging and overheating, causing the specific gravity of the electrolyte to become depressed, that it can become difficult to provide an economically justifiable life prolonging treatment.

What is needed is a test, suitable for carrying out on location, to identify batteries suffering from a condition likely to prevent a favorable outcome to life prolonging treatment, before commencing or during the course of treatment.

While it is certainly possible for qualified servicing personnel to carry out a test procedure based on the specific gravity of the electrolyte in the battery using a hydrometer, the necessary procedures and the cost of testing can be a disadvantage. In addition, the hydrometers used to measure the specific gravity of battery electrolyte are not calibrated to read below 1.080, which corresponds to the specific gravity of a normal functioning discharged battery, and so this test procedure will not necessarily identify a battery in poor condition.

It is an object of the present invention to overcome these and other disadvantages by providing a system, means and method for assessing the condition and therefore the viability of the battery, and if viable, proceeding with a life prolongation treatment process.

### BRIEF DESCRIPTION OF THE DRAWINGS

FIG. 1 is a schematic representation of a mixing or dosing arrangement for combining water with either one or both dosing compositions of the invention.

FIG. 2 is a schematic representation of a container, vessel or conduit for holding or transmitting a flowable mixture of the water and one or both dosing composition of the invention.

FIG. 3 is a schematic representation of a alternative embodiment using a generally similar container, vessel or conduit, including a separate inlet and outlet for the flowable mixture.

FIG. 4 is a schematic representation of a battery cell replenishment arrangement for administering the flowable mixture.

### DETAILED DESCRIPTION OF THE INVENTION

The invention provides unitary means to achieve diverse functionality, selectively employing a battery water replenishment system to deliver a battery life extending composition and/or a battery condition evaluating composition, as an accompaniment to battery replenishment water.

Typically the battery is a lead-acid battery and the replenishment water and accompanying compositions are administered to the electrolyte of the cells of the battery.

A variety of substances can be administered to lead-acid batteries in the context of maintenance, restoration and life prolongation. For example, suitably purified water is administered routinely in accordance with established maintenance practice.

It is sometimes necessary to raise the specific gravity of a battery electrolyte through the addition of strong sulfuric acid, in order to restore, for example, the ampere-hour capacity of the battery. Sometimes battery users administer sulfation remedies consisting of proprietary compositions formulated to restore at least a portion of the original battery capacity following inadvertent misuse of the battery.

Although restoration treatment can, superficially, appear to be providing life extension, such extension would be relative to an already shortened life, and is unlikely to be of any benefit in relation to a life expectancy of a correctly used battery.

Substances that are capable of providing battery life prolongation over and above normal battery life expectancy include certain types of expanders that can provide superior porosity of the negative electrode active mass and special separator plate formulation that help to reduce antimony poisoning of the negative electrodes. The battery life extending composition of the invention is in this class of materials insofar it acts, inter alia, to reduce erosion of the positive electrodes so as to extend the life of the battery over and above normal life expectancy.

The battery condition evaluation composition is a maintenance aid intended to be used infrequently and at the option of the battery operator in support of the battery life extending composition. An advantage of the battery life extending composition of the invention is that it can be used as part of the battery maintenance procedure, as an accompaniment to battery replenishment water, using the same routine as for replenishing and thereby requiring an absolute minimum of additional operator intervention.

An advantage of the battery condition evaluation composition is that it can be administered in a manner practically identical to the administration of the battery life extending composition, using practically identical equipment-indeed, it can optionally be administered concurrently.

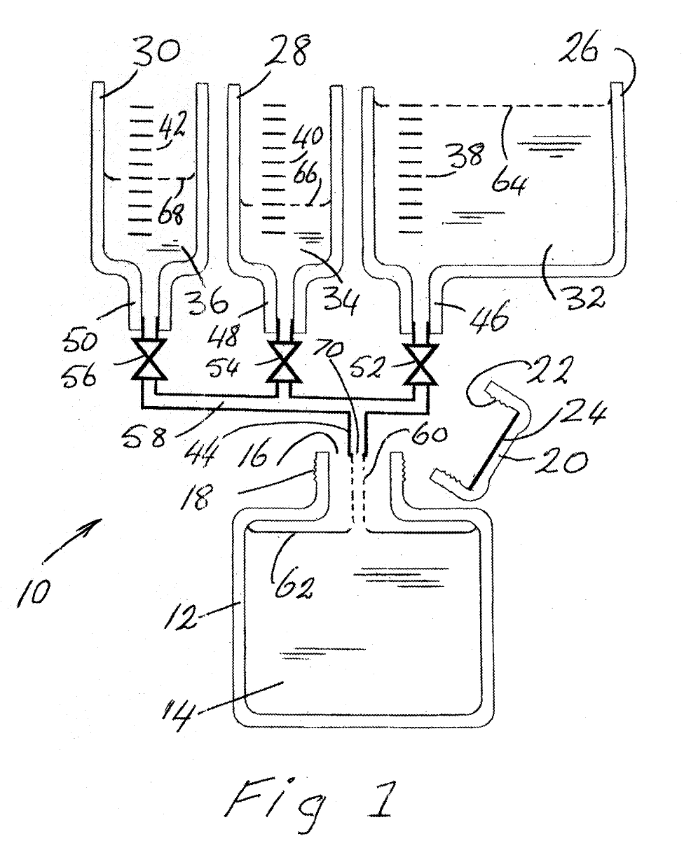

Referring to FIG. 1, a mixing or dosing arrangement (10) is shown for filling a container, conduit or vessel (12), which is used for receiving flowable materials therein from a flowable material combining manifold (58) and to transfer flowable materials therefrom to a suitable battery. The mixing or dosing arrangement (10) has a battery replenishment water source or reservoir (26), a battery condition evaluating composition container (28), and a battery life extending composition container (30) which are all connectable to the flowable material combining manifold (58), with valves used to control the flows for properly dosing the above described fluids into the container vessel or conduit (12).

While a water reservoir (26) is shown, a directly plumbed connection to a water supply could also be used, hence the term “water source or reservoir” has been used. For exemplary purposes, the water reservoir type of system will be hereafter described. The water reservoir (26) contains an amount of battery replenishment water (32) sufficient to establish a level (64), corresponding, for example, to a maximum indicated by a volume indicator (38). Similarly, a battery condition evaluating composition (34) is provided in an amount sufficient to establish a level (66), corresponding, for example, to a third graduation on a volume indicator (40). Similarly, a battery life extending composition (36) is provided in an amount sufficient to establish a level (68), corresponding, for example, to a fifth graduation on a volume indicator (42). These levels are chosen to assure adequate supplies of the various fluids prior to mixing.

The container, conduit or vessel (12) will preferably be empty at this point. The container has a closure cap (20) having a screw thread (22), adapted to engage a corresponding threaded wall (18) which surrounds an opening (16). For filling, the cap is disengaged so as to leave the opening (16) unimpeded for receiving a predetermined ratio of a flowable mixture (14).

The mixing or dosing procedure is commenced by operating a set of flow control valves, comprising a replenishment water flow valve (52), a battery condition evaluating composition flow control valve (54) and a battery life extending composition flow control valve (56) according to a desired volumetric ratio of the fluids being supplied, so as to prepare a correct combination of ingredients for preparing the flowable mixture (14).

On opening the flow control valve (52), the battery replenishment water (32) is able to flow via an outlet (46) and the flow control valve (52) into the flowable material combining manifold (58). On opening the flow control valve (56) the battery life extending composition (36) is able to flow via an outlet (50) and the flow control valve (56) into the flowable material combining manifold (58).

Upon operating a requisite combination of the flow control valves (52, 54 and 56) the resulting flows provide for mixing or dosing of these ingredients within the manifold (58) so as to provide the required combination of constituents of the suitably prepared flowable mixture (14), causing a flow of the suitably prepared flowable mixture (14) out of the manifold (58), via an outlet tube (44) and outlet opening (70), thereby to provide fluid communication with the flowable mixture and to form a flowable mixture stream (60) delivered into the container, conduit or vessel (12). While a simple tube is shown, an inline mixer may be used to facilitate the mixing process prior to deposit in the container (12).

During operation, all three flow control valves (52, 54 and 56) may be opened or the flow control valve (52) and either the flow control valve (54) or the flow control valve (56) may be opened, in various combinations, as well as to various degrees. In one embodiment, the flow control valves (52, 54 and 56) are conveniently arranged to remain open until the corresponding battery replenishment water (32), the battery condition evaluation composition (34) and/or the battery life extending composition (36) have been substantially drained out of their respective reservoir (26), container (28) and/or container (30). In so doing, the volumes of the water (32), the composition (34) and/or composition (36) contributing to the makeup of the suitably prepared flowable mixture (14) can be controlled with an acceptance degree of accuracy.

It will be evident that the proportions in which the water (32), the composition (34) and/or the composition (36) contribute to the makeup of the suitably prepared flowable mixture (14) may be advantageously varied by arranging to vary the extent to which the levels (64, 66 and 68) correspond to the graduations of the volume indicators (38, 40 and 42), respectively, prior to operating the flow control valves (52, 54 and/or 56).

Following a cessation of flow from the outlet opening (70), concluding the mixing or dosing procedure, the means external to a battery for receiving therein and providing fluid therefrom, namely, the container, conduit or vessel (12), will typically have received a volume of the suitably prepared flowable mixture (14), thereby to provide a level (62) in the container, conduit or vessel (12).

Thereafter the container, conduit or vessel (12) may, optionally, be withdrawn from the vicinity of the outlet opening (70) to facilitate closure through engagement with the closure cap (20), so as to sealingly apply a gasket (24) housed in the closure cap (20) across the opening (16), generally as shown in FIG. 2.

The container, conduit or vessel (12) is shown inverted in FIG. 2 as a way of emphasizing the reliability of the seal provided by the gasket (24) across the opening (16). This should not be construed as implying that inversion is a preferred procedure which, indeed it is not.

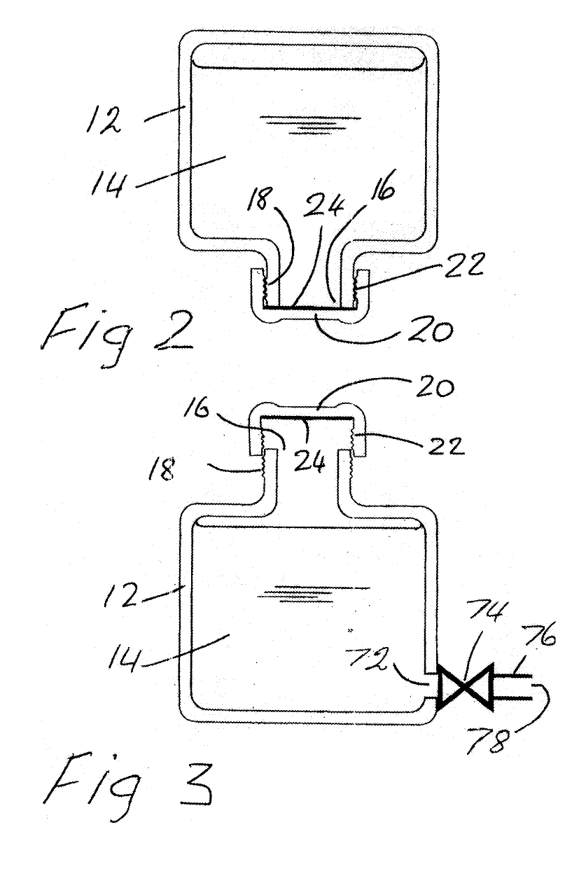

The means external to a battery for receiving therein and providing therefrom, namely, the container, conduit or vessel (12) can, optionally, be equipped with an outlet (72), a control valve (74), an outlet tube (76) and an opening (78), as shown in FIG. 3, arranged to facilitate a flow of the suitably prepared mixture (14) out of the container, conduit or vessel (12). This enables an operator, optionally, to assign the means external to a battery for receiving therein and providing therefrom, the container, conduit or vessel (12) to a role or function equivalent to a through-flow conduit or pipe, by virtue of an inlet provided by the opening (16) and an outlet provided by the outlet (72).

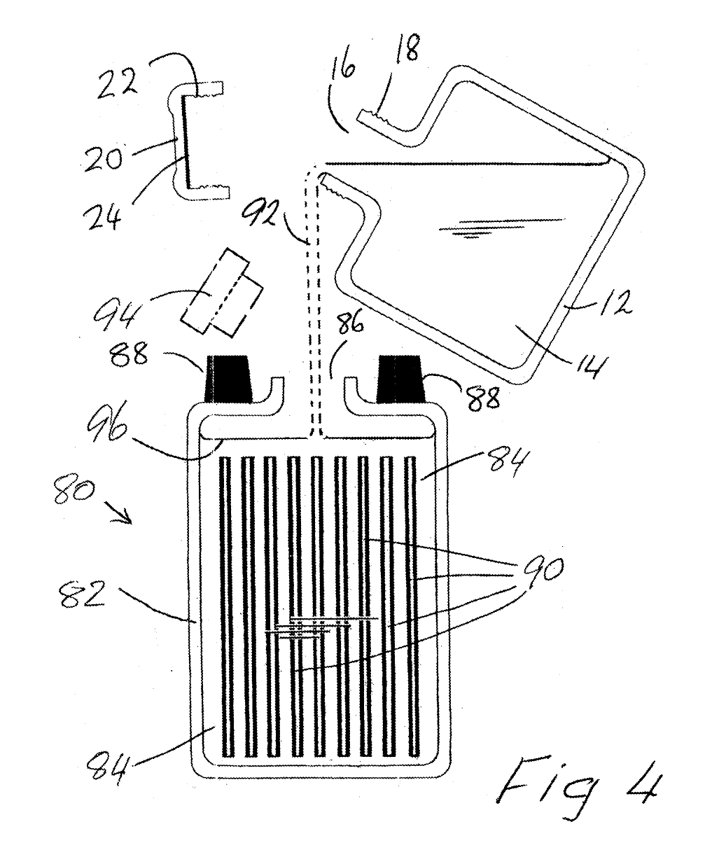

Referring to FIG. 4, the mixture (14) is shown being administered to a battery cell (80) schematically, in a form of a stream or flow path (92). While so shown, it will be understood that the mixture (14) can be added to the cell in many ways, and optionally may be made to flow, be poured, siphoned, pumped, gravity fed, piped, or transmitted according to an operator's preference, thereby to prove fluid communication of the flowable mixture with the cell, which can include the use of a single point battery watering system, (not shown), all being collectively represented by the stream or flow path (92).

The battery cell (80) is usually arranged with other, similar cells in a grouping known as a battery. The battery cell (80) includes a suitable enclosure (82), a sulfuric acid electrolyte (84), an access or venting aperture (86) which normally has a vent plug (94), which plug is typically removed from the aperture (86) to assist with administration of the suitably prepared mixture (14). The battery cell (80) further includes at least two terminals (88) electrically connected to a set of battery electrodes or plates (90) that are normally kept submerged in the electrolyte (84). In use the electrolyte (84) normally undergoes electrolysis and evaporation necessitating replenishment by means of addition of water, preferably by periodic addition of the suitably prepared mixture (14).

The means external to a battery for receiving therein and providing therefrom is depicted in the form of a container and as such is removable and transportable to the same extent as any conventional package, for example, by a person carrying it, or by truck, train, ship and airplane. A variation thereof, illustrated in FIG. 3 includes the outlet (72), the control valve (74), the outlet tube (76) and the opening (78), thereby facilitating a controllable discharge of the suitably prepared mixture (14), from the opening (78), in the same from as the stream or flow path (92), into the battery cell (80), via the aperture (86).

Inclusion of the outlet (72), the control valve (74), the outlet tube (76) and the opening (78) provides sufficient versatility to enable operation of the means external to a battery for receiving therein and providing therefrom, namely, the container, conduit or vessel (12), so as to maintain a position of the opening (16) to accept the suitably prepared mixture (14) from the outlet opening (70), while simultaneously maintaining a position of the opening (78) to provide a discharge of the suitably prepared mixture (14) in the same form as the stream or flow path (92), into the battery cell (80), via the aperture (86). In this configuration it can advantageous to sealingly join the outlet opening (70) and opening (16) so as to maintain an enduring flow path for the flowable mixture stream (60) and, as such, provide a control over the rate of flow of the flowable mixture stream (60) through operation of the control valve (74), for example, inhibiting the flowable mixture stream (60) when the control valve (74) is closed and enabling it when the control valve (74) is open. This form of control is especially useful when the stream or flow path (92) takes the form of a single point battery watering system at the option of an operator.

The preferred material for the battery life extending composition (36) is n-alkyl dimethyl benzyl ammonium salt, the salt optionally being a chloride; and the preferred material for the battery condition evaluating composition (34) is hexamethyl pararosaniline salt, commonly known as gentian violet or crystal violet, the salt optionally being a chloride. Gentian violet is a common topical disinfectant and can be used as an acid-base indicator. Crystal violet is essentially the same as gentian violet and is commonly used a biological stain as well as an acid-base indicator. When used as an acid-based indicator it has a deep violet color at pH 7, remaining substantially violet down to pH 1.8, changing through green to yellow at pH 0.0. Hence it is also termed a colorizing agent.

For convenience, the concentration of the n-alkyl dimethyl benzyl ammonium salt, as the preferred material for the battery life extending composition (36) is not 100 percent, but is typically, although not exclusively pre-diluted in water. It is usable at 80 percent concentration, although its viscosity would be high. It is more preferably pre-diluted to between 10 percent and 0.02 percent. Similarly, the concentration of gentian violet, as a preferred material for the battery condition evaluating composition (34), is not 100 percent, but it is typically, although not exclusively pre-diluted in water. It is usable at 0.1 percent concentration, although its propensity for staining the battery condition evaluating composition container (28) at this concentration could be sufficiently high to merit a lower concentration, for example, between 0.01 percent and 0.000001 percent.

N-alkyl dimethyl benzyl ammonium and hexamethyl pararosaniline are both cationic, despite being organic compounds, both having a nitrogen atom incorporated in their respective molecules with four covalent bonds to carbon and a fifth ionic bond, usually but not exclusively, to chloride. Both rely on their nitrogen to provide a useful solubility in aqueous solutions. Both are drawn out of solution from sulfuric battery acid in the presence of active negative lead-acid battery electrodes or plates. Furthermore, both can be used as disinfectants in the replenishment water for batteries to control algae growth. Gentian violet is commonly used to treat minor skin abrasions and small cuts and n-alkyl dimethyl benzyl ammonium as a contact lens solution preservative.

The usefulness of the invention stems from the versatility of the mixing or dosing arrangement (10), inclusive of the means external to a battery for receiving therein and providing therefrom, the container, conduit or vessel (14) and the properties of the battery life extending composition (36) and the battery condition evaluating composition (34), insofar the compositions (36 and 34) are complementary in the battery replenishment provisions of the invention.

According to the invention, the extent to which the respective volumes of the battery replenishment water (32), the battery life extending composition (36) and the battery condition evaluating composition (34) can contribute towards the total volume of the suitably prepared mixture (14) is variable. In this regard, since the battery replenishment water (32) forms the basis or the carrier for the compositions (36 and 34), at least a significant portion of the total volume of the suitably prepared mixture (14) is typically contributed by the battery replenishment water (32).

The balance of the total volume of the suitably prepared mixture (14) will, substantially, be contributed by the battery life extending composition (36) and the battery condition evaluating composition (34), wherein the respective volumes of the compositions (36 and 34) are selectable, by virtue of suitable operation of the control valve (56) with respect to the composition (36) and control valve (54) with respect to the composition (34). The combined volumes of the compositions (36 and 34) cannot be zero, but the volume of either the battery life extending composition (36), or the volume of the battery condition evaluating composition (34), can be zero, with the complementary composition contributing to the balance of the total volume of the suitably prepared mixture (14).

It will be evident to a person skilled in the art that with a proper objective in mind, if the control valve (54) is not opened, the container (28), together with the control valve (54) may, optionally be deactivated, be set aside or be omitted for the duration the control valve (54) would have remained closed. This applies equally to the control valve (56) and the container (30). In this regard the mixing or dosing arrangement (10) remains adaptable to providing a mixing or dosing capacity in respect of the battery replenishment water (32), the battery condition evaluating composition (34) and the battery life extending composition (36). Such modifications as may be easily be implemented in the described embodiments are intended to fall within the spirit and scope of the invention.

The above described battery condition evaluating composition will now be discussed in more detail. As stated above, the battery condition evaluating composition invention may optionally be a colorized composition, which may be incorporated by premixing to form a colorized battery life extending composition, but is more preferably, as described above, combined using the mixing or dosing arrangement discussed above. It should be noted that the battery life extending composition of the present invention can be any suitable battery life extending composition, by way of example, although not exclusively limited to the battery life extending compositions disclosed in U.S. Pat. No. 6,635,387.

Optionally colorizing the battery life extending composition with a pH sensitive colorizing agent makes it possible to use the colorized composition for identifying a battery in a condition that has deteriorated to an extent a life extending treatment is most unlikely to be effective.

The colorized composition preferably uses gentian violet for giving a visual assessment of battery condition. While gentian violet in solution is commonly known for its use as an antiseptic for the treatment of minor cuts and skin abrasions, it is also in use as a laboratory stain and acid-base indicator under the name crystal violet (hexamethyl pararosaline salt).

A surprising discovery was made identifying gentian violet as being suitable for use in assessing the condition of a battery. It was found that genetian violet was particularly sensitive, when administered to a sample of electrolyte of a lead-acid battery suspected of being in a condition where it has lost its vitality, of confirming whether the suspect battery was likely to be in an insufficiently active condition to benefit from a life prolongation treatment.

In use, a suitable quantity of a battery condition evaluating composition containing a colorizing agent such as gentian violet is administered to a lead acid battery electrolyte as discussed above. If the battery has not suffered from factors including, but not limited to, over-discharging, insufficient charging and overheating, which can result in sulfation, and can still benefit from the life prolongation treatment, the gentian violet typically turns yellow. If the battery has so suffered and is in a condition where it cannot benefit from the life prolongation treatment, the gentian violet usually turns a greenish color, ranging from a yellow-green to a blue-green. If the gentian violet remains violet, the electrolyte contains little or no sulfuric acid and the reason for this should be ascertained. If the gentian violet color becomes bleached out, perhaps browning to a certain extent, the electrolyte is likely to be alkaline and the associated battery type should be investigated.

As discussed above, a battery condition evaluating composition may conveniently be combined with the battery life extending composition by the incorporation of the colorizing agent with the battery condition evaluating composition. Thus, the operator would need only have available the suitably prepared mixture (14), as discussed above. He can then take a small sample of the electrolyte, add the mixture, and immediately and readily determine if the battery is in a condition where it can benefit from receiving a dosage of the prepared mixture.

The preferred battery life extending composition of the present invention includes an organic compound possessing between 8 and 36 carbon atoms and preferably includes at least one alkyl aspect having between 8 and 30 carbon atoms, more preferably having between 12 and 16 carbon atoms. The battery life extending composition can be based on a carboxylate, succinate, sulfonate or group V element aspect, the latter being, although not exclusively limited to, nitrogen. Typically the battery life extending composition includes nitrogen in a configuration causing the life extending composition to be soluble in an aqueous medium including dilute sulfuric acid. A preferred life extending composition of the invention is n-alkyl dimethyl benzyl ammonium salt.

The battery life extending composition is conveniently combined with a suitable quantity of water and may conveniently receive processing in combination with the water by way of ion exchange, pH or conductivity adjustment. The processing typically reduces any potentially harmful ions including, but not limited to chloride and metal ions.

Incorporation of the battery life extending composition into the battery can be achieved in a variety of ways, to suit the user.

Various approaches, in no particular order of merit, include an addition of the battery life prolongation composition to suitably processed bulk water, for distribution and use as replenishment water for batteries.

The battery life extending composition can be prepared as a concentrate by addition to a limited quantity of water, distributed and on location be added to sufficient water to provide replenishment for batteries.

Addition of the battery life extending composition to the water can be achieved directly, by measuring out suitable quantities of the battery life extending composition and the water and discharging the battery life extending composition into the water, using containers ranging in size from small beakers, to bulk tanks, as convenient.

Addition can be achieved by a dosing device adapted to provide a predetermined ratio between the battery life extending composition and the water, wherein the dosing device provides a merging of a flow of the water and a flow of the battery life extending composition, thereby to furnish a substantially constant supply of the resulting mixture, which may be drawn off, as convenient.

The addition of the battery life extending composition to the water, as described, is arranged to provide a mixture or solution wherein the battery life extending composition constitutes a portion corresponding to 5 to 800 000 parts per million, (ppm) by weight, or milligrams per litre in the water upon incorporation of the battery life extending composition into the battery.

More preferably, it is arranged to constitute a portion that corresponds to 20 to 100,000 ppm, even more preferably 100 to 2 000 ppm and most preferably a figure close to 800 ppm as practical circumstances will allow. The battery may, occasionally, be provided with water only, thereby having little or no adverse effect on the treatment overall and therefore such interruptions should not be seen as a deviation in the spirit or diminution in the effectiveness of the invention.

Administering of the mixture can be controlled by a suitable valve adapted to administer the mixture until the battery electrolyte has risen to a suitable level whereupon the valve changes from being open to being closed. Typically, the valve is included in a battery watering gun or a single point battery watering device. The valve can, optionally, be manually controlled, or by a suitable electrolyte level sensing means, for example, a float.

It will be evident to persons skilled in the art that batteries subject to unsatisfactory operating conditions, including but not limited to over-discharging, insufficient charging and overheating—irrespective whether these batteries are receiving life prolonging treatment or not—will be in a degraded condition and are unlikely to achieve their full potential service life and, indeed, under the worst operating conditions can suffer catastrophic failure.

In situations where the condition of the battery has deteriorated to an extent treatment can no longer be effective, the simple test procedure described would assist in preventing needless expenditure on the continued use of the battery life extending composition with such batteries, and additionally may allow removal from service before a failure in use occurs, avoiding disruptions and additional maintenance expense.

In U.S. Pat. No. 6,635,387, the preferred composition for prolonging the life of a battery is consumed in the battery and in order to maintain an active amount of the composition in the battery electrolyte, a means for applying the composition progressively is required. However, battery operators may not become aware of the comparatively small timescale that can be involved in the process of consumption without the use of dedicated chemical analytical equipment.

An assessment of the rate of consumption sufficiently informative for practical use can be made, again using the colorized composition, preferably colorized with gentian violet as the colorizing agent. In a second surprising discovery, use of such a colorizing agent provides a visual assessment for estimating the general rate of consumption of the battery life extending composition in a battery by using the colorized composition to simulate the effects of a battery life extending composition. This is done by incorporating the colorized composition into the battery and administering it to the battery electrolyte in the same way, in the place of or as a supplement to the preferred battery life extending composition.

Upon being administered to the electrolyte of a satisfactorily functioning battery, for example, as a suitably prepared mixture with the battery replenishment water, the gentian violet turns yellow. The intensity of the yellow will be in proportion to the resulting concentration of the gentian violet in the battery electrolyte. The concentration of the gentian violet in the replenishment water being administered to the electrolyte can be 800 ppm, although this can be varied and the gentian violet may be used in combination with the battery life extending composition to form a colorized battery life extending composition, together forming the suitably prepared mixture with the battery replenishment water.

Accordingly, provided a sufficient concentration is administered, the yellow coloration can be expected to fade away altogether, generally as an analogue to the rate of consumption that would be experienced by the battery life extending composition. The gentian violet is thus a rate of consumption simulator, and in this context is ideally restricted to a single treatment, easily enough for a visual assessment to be obtained.

Without being bound by any explanation, the gentian violet shares a particular characteristic with the n-alkyl dimethyl benzyl ammonium salt. While both are organic, both are also cationic compounds, rendering them soluble in water and causing them to be attracted to negative surfaces while in solution. The mechanism that causes the battery life extending composition to be consumed in the battery affects both the gentian violet and the n-alkyl dimethyl benzyl ammonium salt although only the n-alkyl dimethyl benzyl ammonium salt is imbued with a sufficient life extending capacity.

Gentian violet, as an acid-base indicator and/or rate of consumption simulator of the invention constitutes a suitable colorizing agent. Other suitable indicator compounds that may be used to practice the invention include compounds possessing a requisite molecular structure, for example, although not limited to ethyl violet. The suitable indicator compound undergoes a color change from a first color, typically although not exclusively violet above pH 3.0, to a second color, typically although not exclusively yellow below pH 0.0 and is cationic in solution. Gentian violet was selected as the agent of choice since it is in common use and is, perhaps, therefore the easiest obtainable chemical substance for use in practicing the invention.

Typically, although not exclusively, materials including but not limited to the suitable colorizing agent and/or the preferred battery life extending composition and a suitable quantity of battery replenishment water can be incorporated into the battery by means external to the battery for receiving therein and providing therefrom, for example, by transmitting a flowable mixture of the aforesaid materials by way of a suitable container, vessel or conduit (12), into the electrolyte of the battery.

Administering of the mixture can be controlled by a suitable valve adapted to administer the mixture until the battery electrolyte has risen to a suitable level whereupon the valve changes from being open to being closed. Typically, the valve is included in a battery watering gun or a single point battery watering device. The valve can, optionally, be manually controlled, or by a suitable electrolyte level sensing means, for example, a float.

Conveniently, a suitable portion of the battery electrolyte may be withdrawn from the battery, prior to, or subsequent to administering the mixture, thereafter optionally not being returned to the battery, the portion withdrawn prior to administering receiving substantially the entire volume of the mixture.

Optionally, the visual assessment for color change can be made on the portion withdrawn prior to administering the mixture.

If desired, the visual assessment for color fading can be made on the portion withdrawn subsequent to administering the mixture.

It will be evident to persons skilled in the art that electrolyte in lead-acid batteries can stratify and requires to be circulated within the cells prior to any quantity being withdrawn for an evaluation. Furthermore, that withdrawing of a suitable portion of the electrolyte and subsequent optional return to the battery of the withdrawn portion can conveniently be carried out using, by way of example, a hydrometer or hypodermic syringe, (without steel needle), their relative transparency assisting with the visual assessment, and that suitable additional vessels may be used to assist in the process.

While particular embodiments of this invention have been described, it will be understood, of course, that the invention is not limited thereto since many obvious modifications can be made, and it is intended to include within this invention any such modifications as will fall within the spirit and scope of the appended claims.

What is claimed is:

1. An apparatus for providing a flowable mixture for use with a lead-acid battery comprising:
means external to a battery for receiving therein and providing fluid therefrom which is used for receiving flowable materials therein and to transfer flowable materials therefrom to the lead acid battery;
a battery replenishment water source or reservoir connectable by fluid communication to the means external to a battery for supplying battery replenishment water thereto;
a suitable number of containers, each container holding therein at least one composition selected from the group consisting of a battery life extending composition, a battery condition evaluating composition, and combinations thereof, the suitable number of containers connectable by fluid communication to the means external to a battery for supplying the at least one composition thereto;
the apparatus having means for supplying a sufficient amount of the battery replenishment water and the at least one composition in a combined combination form as the flowable mixture to the means external to a battery for receiving therein and providing fluid therefrom.

2. The apparatus of claim 1 further comprising a flow material combining manifold, means for controlling the flows from the replenishment water source and the suitable number of containers for properly dosing the fluids therefrom into the flowable material combining manifold for mixing therein to form the flowable mixture supplied to the means external to the battery for receiving therein and providing fluid therefrom.

3. The apparatus of claim 1 wherein two containers are provided.

4. The apparatus of claim 1 further comprising a reservoir containing the replenishment water, a container for holding a battery evaluating composition and a container for holding a battery life extending composition, each being dosable in predetermined quantities for forming the flowable mixture.

5. The apparatus of claim 1 wherein the battery evaluating composition is an acid-base indicator.

6. The apparatus of claim 1 wherein the battery evaluating composition is an acid-base indicator having a defined indicator state in full strength battery acid.

7. The apparatus of claim 1 wherein the battery evaluating composition is genetian violet.

8. The apparatus of claim 1 wherein the battery life extending composition is n-alkyl dimethyl benzyl ammonium salt.

9. The apparatus of claim 1 further comprising a set of flow control valves, having a replenishment water flow valve (52), a battery condition evaluating composition flow control valve (54) and a battery life extending composition flow control valve (56) for adjusting a desired volumetric ratio of each fluid supplied therethrough.

10. The apparatus of claim 1 wherein the means external to a battery for receiving therein and providing therefrom has an outlet (72), a control valve (74), an outlet tube (76) and an opening (78), arranged to facilitate a flow of the flowable mixture (14) out of said means.

11. A method for providing a flowable mixture for use in a lead acid battery comprising:
providing replenishment water, and at least one composition containing a battery evaluating composition, a battery life extending composition or combinations thereof;
mixing predetermined amounts of the water and the at least one composition to produce the flowable mixture;
providing means external to a battery for receiving therein and providing fluid therefrom (12);
delivering the flowable mixture into the means external to a battery for receiving therein and providing fluid therefrom (12); and,
dosing the flowable mixture from the means external to a battery for receiving therein and providing fluid therefrom (12) into the lead acid battery.

12. The method of claim 11 further comprising providing a flow material combining manifold, controlling the flows of the replenishment water source and the at least one composition to the flow material combining manifold, for forming the flowable mixture supplied to the means external to the battery for receiving therein and providing fluid therefrom.

13. The method of claim 11 further comprising providing two containers.

14. The method of claim 11 further comprising providing a water reservoir for holding the replenishment water, providing a container for holding a battery evaluating composition and providing a container for holding a battery life extending composition, and dosing each fluid contained in each container and the reservoir in predetermined quantities for forming the flowable mixture.

15. The method of claim 11 further comprising providing an acid-base indicator as the battery evaluating composition.

16. The method of claim 11 further comprising providing an acid-base indicator having a defined indicator state in full strength battery acid as the battery evaluating composition.

17. The method of claim 11 further comprising providing genetian violet as the battery evaluating composition.

18. The method of claim 11 further comprising providing n-alkyl dimethyl benzyl ammonium salt as the battery life extending composition.

19. The method of claim 11 further comprising providing a set of flow control valves, the set having a replenishment water flow valve (52), a battery condition evaluating composition flow control valve (54) and a battery life extending composition flow control valve (56), and, using the set of flow control valves for adjusting a desired volumetric ratio of each fluid supplied therethrough.

20. The method of claim 11 further comprising providing means external to a battery for receiving therein and providing therefrom having an outlet, a control valve, an outlet tube and an opening, arranged to facilitate a flow of the flowable mixture out of said means.

21. The method of claim 11 further comprising providing a colorized battery condition evaluating composition that is pH sensitive, and, observing if there is a color change when the flowable mixture is initially added to a battery electrolyte to determine whether the battery will benefit from receiving a dose of the flowable mixture.
